(19) United States
(12) Patent Application Publication
(10) Pub. No.: US 2008/0253558 A1
(43) Pub. Date: Oct. 16, 2008

(54) Polynomial-Based Key Distribution System and Method

(75) Inventors: Pim Theo Tuyls, Mol (BE); Marten Erik Van Dijk, Cambridge, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,354

(22) PCT Filed: Sep. 21, 2005
(86) PCT No.: PCT/IB05/53115

§ 371 Date: Mar. 30, 2007

Related U.S. Application Data
(60) Provisional application No. 60/614,731, filed on Sep. 30, 2004.

(51) Int. Cl. H04L 9/28

(52) U.S. Cl. 380/28

(57) ABSTRACT

The present invention relates to a system (600) and method for sharing multiple session keys between low-power devices (701) and more advanced devices (702). A polynomial algorithm with a certain number of parameters is used. A large number of parameters are fixed for the low-power devices (701) and a small number of parameters are fixed for the more powerful devices (702).

The present invention relates to encryption systems. More particularly, the present invention relates to encryption key distribution for generating secure session keys. Most particularly, the present invention is a system and method for polynomial-based encryption key distribution.

The number of applications requiring secure communications between low-power and higher-power devices is growing. For example, in the future buildings will be equipped with low-cost and low-energy sensors that will not only control the temperature in the buildings but will also contribute to a building's security. That is, they will collect information concerning security of the building, such as individuals entering and leaving. They will send the information they gather to a facility, i.e., another point in the building that gathers and processes this information. In this scenario it is important that the gathering point is able to trust the sensor information inputs.

One way to provide a level of trust is to incorporate simple cryptographic tools to secure communication between sensors and the gathering point and to allow authentication of the information being transmitted. However, sensors likely only have a limited amount of power available and ideally these sensors obtain their power form their environment, e.g., solar power or RF powered. Because of this low-power availability, public key cryptography becomes very expensive and makes the device slow. Further, secret key systems require that all participants have a shared secret key in order to communicate securely.

Another application where low-power cryptography is important is Chip-in-Disc, RFID-tag technology. Here the communication takes place between a high-power disc player and a low-power disc. The chip contained therein controls the right of access to the content on the disc. The chip provides keys to the content to the disc player if it is convinced that the player is trustworthy and the disc player will only play the content if it is convinced that the chip can be trusted.

Both of these example applications and others like them need a low-cost and low-power cryptographic key management system. However, such low-cost and low-power systems are very constrained in both storage capacity and computing power.

A prior art scheme suggested by Blundo et al. is based on a scheme of Blom and uses a symmetric polynomial in a scheme of Blom wherein p(x,y): GF(Q)²→GF(q) (q is a prime power), and p(x,y)=p(y, x) is a symmetric polynomial. Suppose, further, that there is only one type of device A and that a device A gets an identity X_{A}∈GF(q) together with the secret polynomial q_{A}(y)=p(x_{A},y). Any two devices A and B can construct a shared secret key K_{A,B}=q_{A}(X_{B})=q_{B}(X_{A}) by communicating their identities to one another and applying the secret polynomial thereto. For a group G, associate with each g∈G a representation Π_{g}, which is a homomorphism from the group G to the space of linear mappings L(V) on some vector space V (this vector space can be the space of polynomials p:GF(q)²→GF(q)≡P). The scheme of Blom is described in R. Blom, Non-Public Key Distribution, Advances in Cryptology-Proceedings of Crypto 82, pps 231-236, 1983 and R. Blom, An Optimal Class of Symmetric Key Generation Systems, Advances in Cryptology-Proceedings of EUROCRYPT84, pps 335-338, 1985, the entire contents of both of which are hereby incorporated by reference. The scheme of Blundo et al. is described in C. Blundo, A. De Santis, A. Herzberg, Skutten, U. Vaccaro, & M. Yung, Perfectly Secure Key Distribution for Dynamic Conferences, Advances in Cryptology-CRYPTO93, pp. 110-125, 1994, the entire contents of which is hereby incorporated by reference.

Consider the matrix group:

$$G = I = \{ ( \begin{matrix}1 & 0 \\ 0 & 1\end{matrix} ) , ( \begin{matrix}0 & 1 \\ 1 & 0\end{matrix} ) \} ,$$

then for g in G the representation Π_{g} of G on the space of linear mappings on the vector space P is given by:

(Π_{g}(p))(x,y)=p(g*(x,y)).

It is clear that this map gives a homomorphism from the group G to L(P). It flows easily from the definition of the group G and that of a symmetric polynomial p that the polynomial p is invariant under the action of the group G.

More generally, let group G act on the vector space V⊕V as follows:

g(x⊕y)=y⊕x

And define p(x,y)= [symbol] [symbol] where P is a symmetric matrix, i.e., [symbol] [symbol] [symbol] [symbol] and [symbol] [symbol] denotes an inner product on V (Note that g²=1 for g in G). Then, it follows that p is invariant under the action of the g group G. Given a matrix P, one can always obtain a symmetric matrix P^{S} as follows

P^{S}=P+P^{T}.

where T stands for the transpose of a matrix.

A polynomial is made invariant in the same way, as follows:

p^{S}(x,y)=p(x,y)+p(y,x)=p(x,y)+p(g(x,y)).

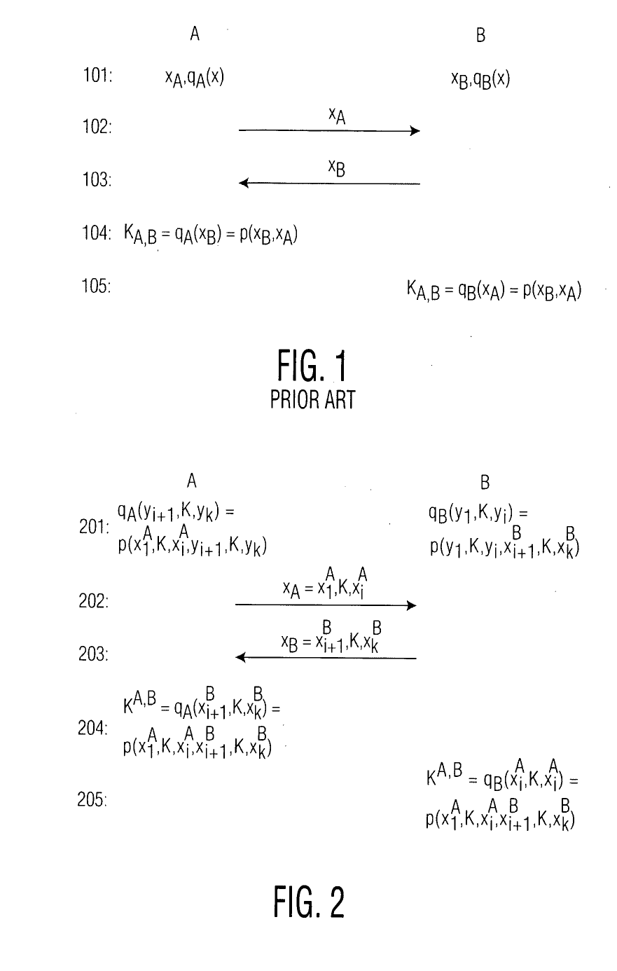

Referring now to FIG. 1, an interaction between two devices of the same type, A and B, goes as follows:

Initialization phase:

1. at step 101 A and B each get an identity and the identical but secret symmetric polynomial p(x,y)=p(y,x) in two variables x and y;

Session Key Generation Phase

2. at step 102A sends its identity x_{A}∈GF(q)to B;

3. at step 103 B sends its identity x_{B}∈GF(q) to A;

4. at step 104 A computes the key using the received identity of B, its own identity and the previously distributed secret symmetric polynomial such that K_{A,B}=q_{A}(x_{B})=p(x_{A},x_{B});

5. at step 105 B computes the key using the received identity of A, its own identity and the previously distributed secret symmetric polynomial such that K_{A,B}=q_{B}(x_{A})=x_{B}, x_{A}); and

6. the shared, identical secret key is K_{A,B}=q_{A}(x_{B})≡q_{B}(x_{A}).

These prior art approaches do not leverage the different capability of devices and do not provide more than one secret session key per use.

Thus, a solution is needed that allows inexpensive low-power devices and expensive higher-power devices to share multiple secret session keys to allow secure communication in the future between these devices.

The system and method of the present invention provide a polynomial-based key distribution scheme that allows low-cost low-power devices to share multiple secret session keys with higher-cost higher-power devices.

A first preferred embodiment of the present invention is a key distribution scheme using polynomials in multiple variables and which applies to at least two kinds of devices.

A second preferred embodiment is a key distribution scheme using polynomials in multiple variables that are invariant under group transformations and which applies to at least two kinds of devices.

A third embodiment for an asymmetric protocol is provided that forces an eavesdropper to break at least one of the more difficult to break device, i.e., a higher-cost, higher-power device.

A fourth embodiment forces an adversary to break at least one harder to break device, i.e., a higher-cost, higher-power device.

FIG. 1 illustrates a prior art approach to shared key generation;

FIG. 2 illustrates a first preferred embodiment of shared key generation, according to the present invention;

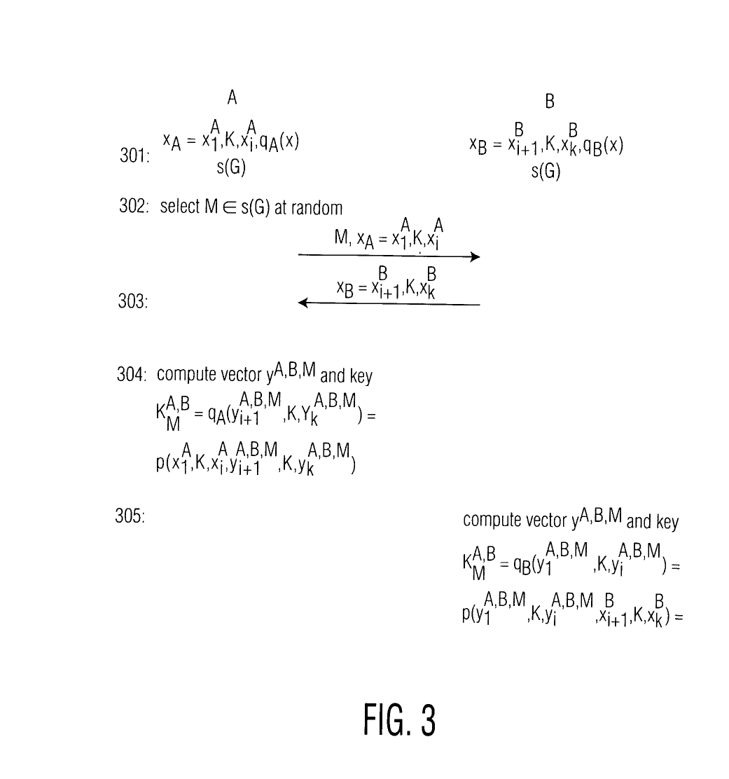

FIG. 3 illustrates a second preferred embodiment of shared key generation, according to the present invention;

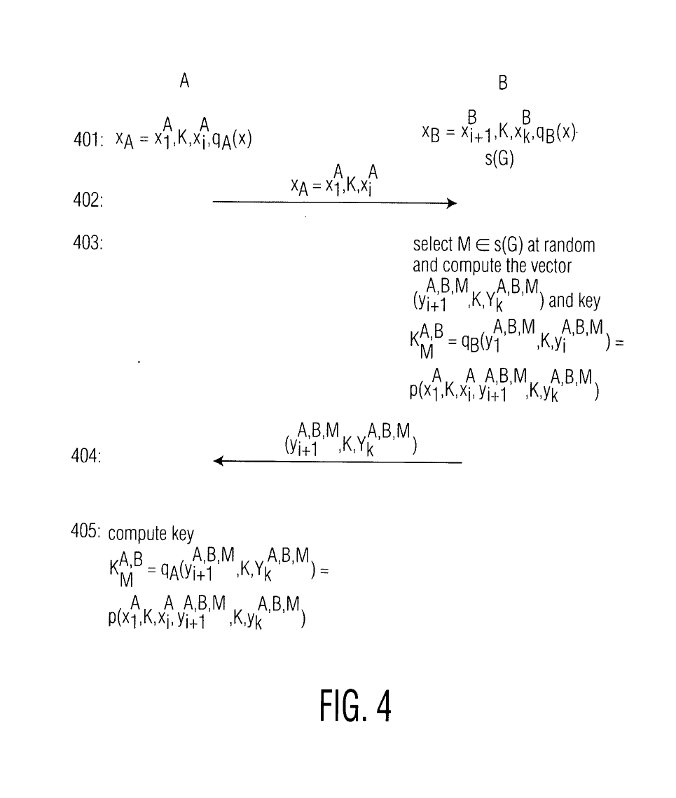

FIG. 4 illustrates a third preferred embodiment of shared key generation, according to the present invention;

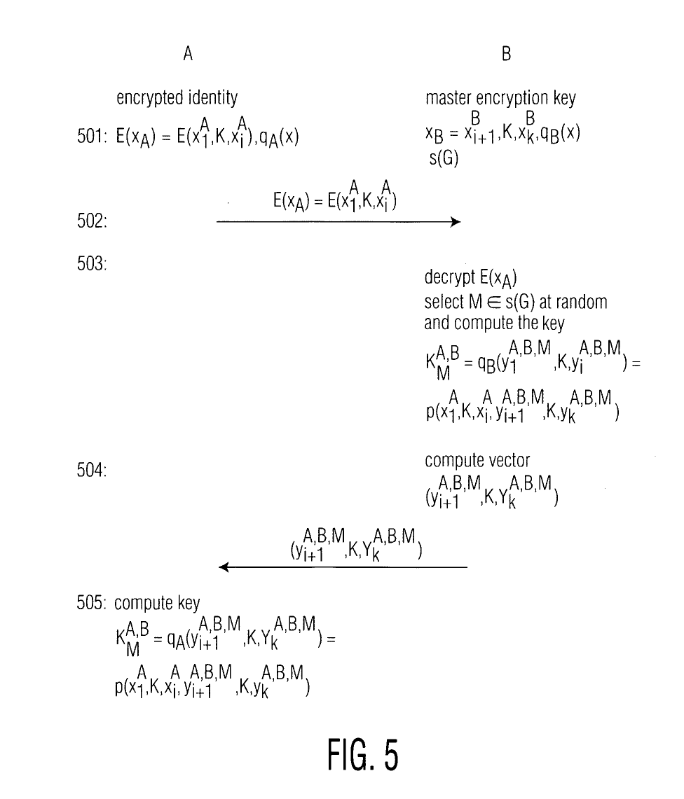

FIG. 5 illustrates a fourth preferred embodiment of shared key generation, according to the present invention;

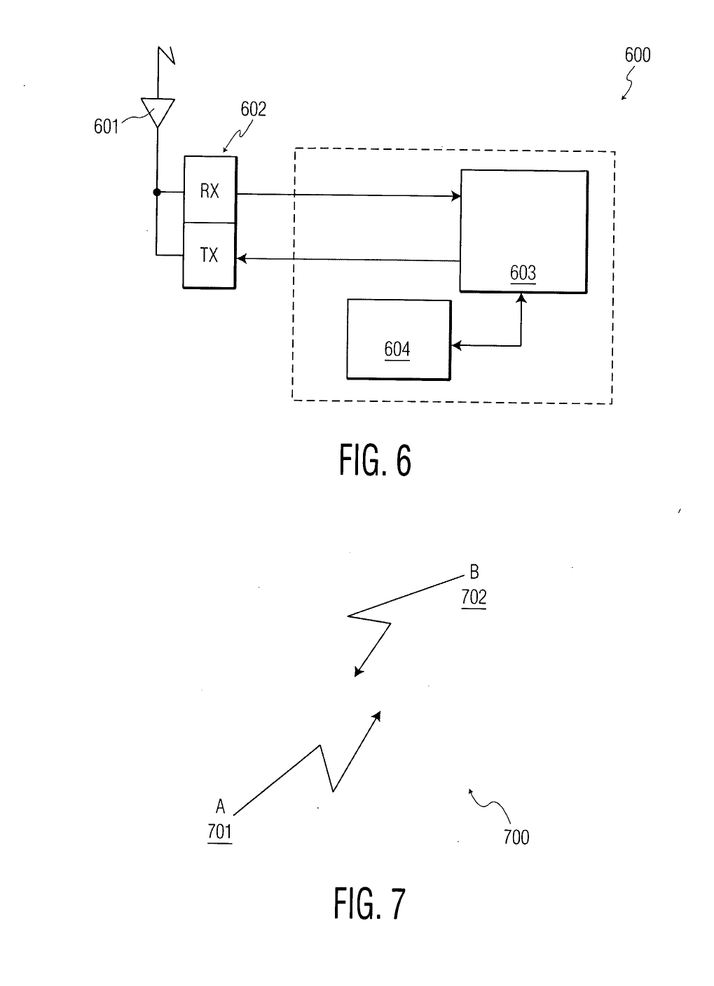

FIG. 6 illustrates a device modified according to the present invention; and

FIG. 7 illustrates a wireless network system comprising at least two devices A and B 702, modified accorded to the present invention.

It is to be understood by persons of ordinary skill in the art that the following descriptions are provided for purposes of illustration and not for limitation. One skilled in the art understands that there are many variations that lie within the spirit of the invention and the scope of the appended claims. Unnecessary detail of known functions and operations may be omitted from the current description so as not to obscure the present invention.

In a first preferred embodiment of the present invention, devices of at least two kinds use distributed multivariate polynomials to construct secret keys.

First, define a polynomial in multiple variables such that the maximum power of

p(x₁, . . . , xₖ):GF(q)^{k}→GF(q)

any of its
variables is at most n−1. Polynomial p(x₁, . . . , xₖ) represents a master key in the distribution scheme and is not stored with any of the devices; only the polynomials q_{A}, q_{B}, etc., which are derived from p are pre-distributed to A, B, etc.

Consider two kinds of devices split into sets A and B. For A∈A define a secret polynomial q_{A} in multiple variables as follows:

q_{A}(yᵢ₊₁, . . . , yₖ)=p(xᵢ^{A}, . . . , xᵢ^{A}, yᵢ₊₁, . . . , yₖ)

and for B∈B define a secret polynomial q_{B} in multiple variables is as follows:

q_{B}(y₁, . . . , yᵢ)=p(y₁, . . . , yᵢ, xᵢ₊₁^{B}, . . . , x_{K}^{B})

after exchanging the xⱼ^{A}'s and xⱼ^{B}'s devices A and B compute their mutually agreed secret key K^{A,B} using their respective secret polynomials:

K^{A,B}=q_{A}(xᵢ₊₁^{B}, . . . , xₖ^{B})=q_{B}(x₁^{A}, . . . , xᵢ^{A}).

Devices of type A need to store n^{k-i}+i elements in GF(q) (polynomial q_{A} has degree n and is a polynomial in k−i variables, hence, we need n^{k-i} coefficients in GF(q) to describe q_{A}, the identity of A costs another i elements in GF(q)) and devices of type B need to store nⁱ+k−i elements in GF(q).

Referring now to FIG. 2, an interaction between two devices of the different types, A and B, proceed as follows:

1. at step 201 A and B each get an identity and a respective polynomial

q_{A}(yᵢ₊₁, . . . , yₖ)=p(x₁^{A}, . . . , xᵢ^{A}, yᵢ₊₁, . . . , yₖ) and

q_{B}(y₁, . . . , yᵢ)=p(y₁, . . . , yᵢ, xᵢ₊₁^{B}, . . . , xₖ^{B})

2. at step 202 A sends its identity x₁^{A}, . . . , xᵢ^{A}∈GF(q) to B;

3. at step 203 B sends its identity xᵢ₊₁^{B}, . . . , xₖ^{B}∈GF(q) to A;

4. at step 204 A computes the key using the received identity of B and the to A previously distributed secret polynomial q_{A} such that

K^{A,B}=q_{A}(xᵢ₊₁^{B}, . . . , xₖ^{B})=p(x₁^{A}, . . . , xᵢ^{A}, xᵢ₊₁^{B}, . . . , xₖ^{B});

5. at step 205 B computes the key using the received identity of A and the to B previously distributed secret symmetric polynomial q_{B} such that

K^{A,B}=q_{B}(x₁^{A}, . . . , xᵢ^{A})=p(x₁^{A}, . . . , xᵢ^{A}, xᵢ₊₁^{B}, . . . , xₖ^{B}); and

6. the mutually agreed secret key is K^{A,B}=q_{A}(xᵢ₊₁^{B}, . . . , xₖ^{B})=q(x₁^{A}, . . . , xᵢ^{A}).

Devices of type A need to store n^{k-i}+i elements in GF(q). Devices of type B need to store nⁱ=k−i elements in GF(q).

In a preferred embodiment, devices of type A are low-cost low-power devices while devices of type B are higher cost devices having more functionality.

In a second preferred embodiment of the present invention, devices of at least two kinds use a distributed multivariate polynomial to construct secret keys, wherein the polynomial is invariant under the action of a certain group. This embodiment provides a way to obtain multiple session keys per each pair of devices that are equivalent in performance to repetition of the first embodiment.

Consider a polynomial:

p(x₁, . . . , xₖ):GF(p^{m})→GF(p^{m})

in multiple variables which is invariant under a group G consisting of k×k matrices over GF(p^{m}). The construction of such a polynomial begins with an arbitrary polynomial P(x),x=(x₁, . . . , xₖ), such that,

$$p ( x ) = {\sum }_{g ∈ G} P ( gx ) = {\sum }_{g ∈ G} {Π}_{g} \cdot P ( x )$$

is invariant under G. That is, for each g∈G the evaluation of p(x)=P(gx)=Π_{g}∘P(x).

Let n−1 be the maximum power of xⱼ in p(x).

Let 1≦i<k and define

s(G)={M∈G:∀x∃y(x₁, . . . , xᵢ, yᵢ₊₁, . . . , yₖ)=(y₁, . . . , yᵢ, xᵢ₊₁, . . . , xₖ)M}

Consider two kinds of devices split into sets A and B. For A∈A and for B∈B, after exchanging the xⱼ^{A}'s and xⱼ^{B}'s devices A and B compute a unique y^{A,B,M} for each matrix M∈s(G) such that their mutually agreed secret key is:

K_{M}^{A,B}=q_{A}(yᵢ₊₁^{A,B,M}, . . . , yₖ^{A,B,M})=q_{B}(y₁^{A,B,M}, . . . , yᵢ^{A,B,M}).

Each pair of devices A and B can share |s(G)| uniformly distributed secret session keys. However, devices of the same kind cannot share secrets.

In addition to the storage described for the first embodiment described above, all devices need to store a parameterization of s(G). For example, if G is a cyclic group then only its generating matrix needs to be stored.

G can be generated, for example, as follows. Let H be a group and define the group G as follows: G={h⊕h|h∈H}. Then M=h⊕h, we have the following equations:

(yᵢ₊₁^{A,B,M}, . . . , yₖ^{A,B,M})=h(xᵢ₊₁^{B}, . . . , xₖ^{B})

(y₁₊₁^{A,B,M}, . . . , yᵢ^{A,B,M})=h⁻¹(x₁^{A}, . . . , xᵢ^{A})

It can be easily shown that if the session keys are equal for M₁,M₂∈G for all devices A and B that this implies that M₁=M₂ and hence all session keys are different (except for accidental collisions).

Referring now to FIG. 3, an interaction between two devices different types, A and B, proceed as follows:

Initialization Phase:

1. at step 301 A and B each gets an identity, a secret polynomial q_{A} and q_{B} respectively, and a parameterization s(G);

Session Key Generation Phase:

2. at step 302 A selects M in s(G) at random and sends M's parameter representation and A's identity x₁^{A}, . . . , xᵢ^{A}∈GF(p^{m})to B;

3. at step 303 B sends its identity xᵢ₊₁^{B}, . . . , xₖ^{B}∈GF(p^{m})to A;

4. at step 304 A computes the key using the received identity of B and its own polynomial q_{A} such that:

K_{M}^{A,B}=q_{A}(yᵢ₊₁^{A,B,M}, . . . , yₖ^{A,B,M})=p(x₁^{A}, . . . , xᵢ^{A}, yᵢ₊₁^{A,B,M}, . . . , yₖ^{A,B,M});

5. at step 305 B computes the key using the received identity of A and its own polynomial q_{B} such that

K_{M}^{A,B}q_{B}(y₁^{A,B,M}, . . . , yᵢ^{A,B,M})=p(y₁^{A,B,M}, . . . , yᵢ^{A,B,M}, xᵢ₊₁^{B}, . . . , xₖ^{B}); and pos

6. the mutually agreed secret key is

K_{M}^{A,B}=q_{A}(yᵢ₊₁^{A,B,M}, . . . , yₖ^{A,B,M})=q_{B}(y₁^{A,B,M}, . . . , yᵢ^{A,B,M}).

In a preferred embodiment, devices of type A are low-cost low-power devices while devices of type B are higher cost devices having more functionality.

A third embodiment is a variation of the second embodiment that allows both devices to compute an identical key without a more difficult to break device revealing its identity.

For a low-cost low power device A∈A and for a higher-power more functional device B∈ B, let A first transmit its identity to the harder to break device B. B then computes the vector (yᵢ₊₁^{A,B,M}, . . . , yₖ^{A,B,M}) using its identity and polynomial. Without revealing its identity, B transmits this vector to A which can now compute K_{M}^{A,B}. This asymmetric protocol does not reveal the identity of B and more important the lower-cost and easier to break device does not need to store a representation of the group G.

Referring now to FIG. 4, an interaction between two devices of the same type, A and B, proceed as follows:

Initialization Phase:

1. at step 401 A and B each get an identity, a secret polynomial, and B gets a parameterization s(G);

Session Key Generation Phase:

2. at step 402 A sends its identity x₁^{A}, . . . , xᵢ^{A}∈GF(p^{m}) to B;

3. at step 403 B selects M in s(G) at random using the previously distributed parameterization of the group s(G) and computes the key using the received identity of A and its own polynomial q_{B} such that

K_{M}^{A,B}=q_{B}(y₁^{A,B,M}, . . . , yᵢ^{A,B,M})=p(x₁^{A}, . . . , xᵢ^{A}, yᵢ₊₁^{A,B,M}, . . . , yₖ^{A,B,M});

4. at step 404 B computes and sends the vector (yᵢ₊₁^{A,B,M}, . . . yₖ^{A,B,M}) to A;

5. at step 405 A computes the key using the received vector and its own polynomial q_{A} such that

K_{M}^{A,B}=q_{A}(yᵢ₊₁^{A,B,M}, . . . , yₖ^{A,B,M})=p(X₁^{A}, . . . , xᵢ₊₁^{A,B,M}, . . . , yₖ^{A,B,M}); and

6. the mutually agreed secret key is

K_{M}^{A,B}=q_{A}(yᵢ₊₁^{A,B,M}, . . . , yₖ^{A,B,M})=q(y₁^{A,B,M}, . . . , yᵢ^{A,B,M}).

Instead of hiding group G, as in the third embodiment, a fourth embodiment hides A's identity from A by storing an encrypted version of A. The encrypted identity of A is sent to B and B then uses a master key (known to all devices in B) to decrypt the encrypted identity of A. This forces an adversary to break at least one harder to break device in B.

If the identities of type A devices are stored in encrypted form in these devices, then an interpolation attack based on getting the q polynomials of A devices does not work. It is essential to know the identities in order for such an attack to work. This means that the attacker is forced to break at least one B device to get to know the master key with which the identities of the A devices are encrypted.

Referring now to FIG. 5, an interaction between two devices of the same type, A and B, proceed as follows:

1. at step 501 A and B each get an identity with A's identity being encrypted=E(x₁^{A}, . . . , xᵢ^{A}), a secret polynomial, and B gets a parameterization s(G);

2. at step 502 A sends its encrypted identity E(x₁^{A}, . . . , xᵢ^{A})∈GF(p^{m}) to B;

3. at step 503 B decrypts the received identity of A, selects M in s(G) at random using the previously distributed parameterization of the group s(G) and computes the key using the decrypted identity of A and its own polynomial q_{B} and such that

K_{M}^{A,B}q_{B}(y₁^{A,B,M}, . . . , yᵢ^{A,B,M})=p(x₁^{A}, . . . , xᵢ^{A}, xᵢ₊₁^{B}, . . . , xₖ^{B});

4. at step 504 B uses its identity and polynomial to compute the vector

(yᵢ₊₁^{A,B,M}, . . . , yₖ^{A,B,M}), which B then sends to A;

5. at step 505 A computes the key using the received vector and its own polynomial q_{A} such that

K_{M}^{A,B}=q_{A}(yᵢ₊₁^{A,B,M}, . . . , yₖ^{A,B,M})=p(x₁^{A}, . . . , xᵢ^{A}, yᵢ₊₁^{A,B,M}, . . . , yₖ^{A,B,M}); and

6. the mutually agreed secret key is

K_{M}^{A,B}=q_{A}(yᵢ₊₁^{A,B,M}, . . . , yₖ^{A,B,M})=q_{B}(y₁^{A,B,M}, . . . , yᵢ^{A,B,M}).

Referring now to FIG. 6, a device modified according to the present invention is illustrated, comprising an antenna 601, a transceiver 602 operably coupled to the antenna to send and receive messages as directed by a polynomial key distribution module 603, and a memory 604 in which the polynomial key distribution module 603 stores various data required by the polynomial key distribution scheme of the present invention.

Referring now to FIG. 7, a wireless network system 700 is illustrated comprising at least two devices A 701 and B 702, modified according to the present invention and device A 701 is different from device B 702 in that A 701 is representative of a low-cost low power set of devices and B 702 is a higher power and functionally more capable device.

In general, type A devices are lower-power devices, such as chip-in-discs, and type B devices are functionally more capable higher power devices, such as disc-players.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation, such as the relative capabilities of the devices, and the teaching of the present invention can be adapted in ways that are equivalent without departing from its central scope. Therefore it is intended that the present invention not be limited to the particular embodiments disclosed as the best mode and alternative thereto contemplated for carrying out the present invention, but that the present invention include all embodiments falling within the scope of the appended claims.

1. A method of generating a common secret between a first device A (701) and a second different device B (702), comprising the steps of:
pre-distributing (201) (301) (401) (501) to said first and second device a respective secret unique identity x₁^{A}, . . . , xᵢ^{A} and xᵢ₊₁^{B}, . . . , x_{K}^{B}
and, based on a master polynomial
p(x₁, . . . xₖ):GF(q)^{k}→GF(q),
respective secret polynomial in multiple variables
q_{A}(yᵢ₊₁, . . . , yₖ)=p(x₁^{A}, . . . xᵢ^{A}, yᵢ₊₁, . . . , yₖ) and
q_{B}(y₁, . . . , yᵢ)p32 p(y₁, . . . , yᵢ, xᵢ₊₁^{B}, . . . , x_{K}^{B})
where
q_{A}(xᵢ₊₁^{B}, . . . , xₖ^{B})=q_{B}(x₁^{A}, . . . , xᵢ^{A});
exchanging (202) (203) (302) said unique identity by at least one of said first device with said second device (402) (502) and said second device with said first device; and
computing (204) (205) (304) (305) (403) (405) (503) (505)by each said first and second device with their respective secret polynomials a common secret key as:
K^{AB}=q_{A}(xᵢ₊₁^{B}, . . . , xₖ^{B})=q_{B}(x₁^{A}, . . . , xᵢ^{A})=p(x₁^{A}, . . . , xᵢ^{A}, xᵢ₊₁^{B}, . . . xₖ^{B}).

2. The method of claim 1, wherein the polynomial is invariant under the action of a pre-determined group G.

3. The method of claim 2, wherein the pre-determined group G comprises k x k matrices over GF(p^{m}) such that:
p(x₁, . . . , xₖ):GF(p^{m})^{k}→GF(p^{m}).

4. The method of claim 2, wherein the polynomial is constructed by performing the following steps:
choosing an arbitrary polynomial P(x), x=(x₁, . . . , xₖ), such that
$$p ( x ) = {\sum }_{g ∈ G} P ( gx ) = {\sum }_{g ∈ G} {Π}_{g} \cdot P ( x )$$
that is, for each g∈G the evaluation of p(x)=P(gx)=Π_{g}∘P(x) is invariant under G;
defining
s(G)={M∈G:∀x∃y(x₁, . . . , xᵢ, yᵢ₊₁, . . . , yₖ)=(y₁, . . . , yᵢ, xᵢ₊₁, . . . , xₖ)M};
after the exchanging step (302), for (n−1) as the maximum power of xⱼ in p(x) and 1≦i<k,
computing y^{A,B,M} (304) (305) (404) (504) for each matrix M∈s(G) such that their mutually agreed secret key is
K_{M}^{A,B}=q_{A}(yᵢ₊₁^{A,B,M}, . . . , yₖ^{A,B,M})=q_{B}(y₁^{A,B,M}, . . . , yᵢ^{A,B,M}).

5. The method of claim 4, wherein G={h ⊕h|h∈H} is a group, M=h⊕h, and
(yᵢ₊₁^{A,B,M}, . . . , yₖ^{A,B,M})=h(xᵢ₊₁^{B}, . . . , xₖ^{B})
(y₁₊₁^{A,B,M}, . . . , yᵢ^{A,B,M})=h⁻¹(x₁₊₁^{A}, . . . , xᵢ^{A}).

6. The method of claim 4, further comprising the steps:
pre-distributing a parameterization of s(G)(301) (401) (501) to at least one receiving device selected from the group consisting of device A and device B; and
choosing at random an element M∈s(G) (302) (403) (503) by the at least one receiving device.

7. The method of claim 6, further comprising the step of sending by the receiving device a parameterization of the chosen element (302) to the other device of the group consisting of device A and device B.

8. The method of claim 6, further comprising the step of sending by device A and device B their respective parts of the solution y^{A,B,M} for M∈s(G) (404) (504) over the channel to device B and device A, respectively.

9. The method of claim 8, wherein:
said exchanging step is performed only by device A (402) (502) which sends the identity of device A to device B;
said computing y^{A,B,M} for each matrix M step further comprises the steps of:
i. device B computing the key (403) (503)
K_{M}^{A,B}=q_{B}(y₁^{A,B,M}, . . . , yᵢ^{A,B,M})=p(x₁^{A}, . . . , xᵢ^{A}, yᵢ₊₁^{A,B,M}, . . . , yₖ^{A,B,M},
ii. device B computing (403) (504) and sending the vector (404) (504)
iii. device A computing (404) (505) the key using the sent vector, the pre-distributed identity and parameterization of the group s(G) such that
K_{M}^{A,B}=q_{A}(yᵢ₊₁^{A,B,M}, . . . , yₖ^{A,B,M})=p(x₁^{A}, . . . , xᵢ^{A}, yᵢ₊₁^{A,B,M}, . . . , yₖ^{A,B,M}), and
K_{M}^{A,B}=q_{A}(yᵢ₊₁^{A,B,M}, . . . , yₖ^{A,B,M})=q_{B}(y₁^{A,B,M}, . . . , yᵢ^{A,B,M}),

10. The method of claim 9, wherein:
said pre-distributing step pre-distributes an encrypted identity (501) as the identity to device A and a master encryption key (501) to device B for decryption of the encrypted identity; and
said computing y^{A,B,M} for each matrix M by device B step further comprises the step of first decrypting (503) the sent identity of device A.

11. A system (700) including at least one first device A (701) and at least one different second device B (702) arranged to execute the method of claim 1.

12. A device (600) configured to operate at least one of the group consisting of the first device A of claim 9 and the second device B of claim 10.

13. The device (600) of claim 11, comprising a memory (604) for storing any of the pre-distributed unique secret identity of device A (701) and device B (702), the secret polynomial of device A (701) and device B (702), and the parameterization of the group G.

14. A system (700) including at least one first device A (701) and at least one different second device B (702) arranged to execute the method of claim 4.

15. A device (600) configured to operate as at least one of the group consisting of the first device A (701) of claim 14 and the second device B (702) of claim 14.

16. The device (600) of claim 15, comprising a memory (604) for storing any of the pre-distributed unique secret identity of device A (701) and device B (702), the secret polynomial of device A (701) and device B (702), and the parameterization of the group G.

17. A system (700) including at least one first device A (701) and at least one different second device B (702) arranged to execute the method of claim 7.

18. A device (600) configured to operate as at least one of the group consisting of the first device A (701) of claim 17 and the second device B (702) of claim 17.

19. The device (600) of claim 18, comprising a memory (604) for storing any of the pre-distributed unique secret identity of device A (701) and device B (702), the secret polynomial of device A (701) and device B (702), and the parameterization of the group G.

20. A system (700) including at least one first device A (701) and at least one different second device B (702) arranged to execute the method of claim 9.

21. A device (600) configured to operate as at least one of the group consisting of the first device A (701) of claim 20 and the second device B (702) of claim 20.

22. The device (600) of claim 21, comprising a memory (603) for storing any of the pre-distributed unique secret identity of device A (701) and device B (702), the secret polynomial of device A (701) and device B (702), and the parameterization of the group G.

23. A computer program product (603) for causing at least one processor to execute the method of claim 1.

24. A computer program product (603) for causing at least one processor to execute the method of claim 4.

25. A computer program product (603) for causing at least one processor to execute the method of claim 7.

26. A computer program product (603) for causing at least one processor to execute the method of claim 9.
